(19) United States
(12) Patent Application Publication
(10) Pub. No.: US 2015/0086030 A1
(43) Pub. Date: Mar. 26, 2015

(54) ELECTRONIC DEVICE AND METHOD FOR CONTROLLING THE SAME

(71) Applicant: KYOCERA Corporation, Kyoto-shi (JP)

(72) Inventor: Shinsuke MORIAI, Osaka (JP)

(73) Assignee: KYOCERA Corporation

(21) Appl. No.: 14/555,540

(22) Filed: Nov. 26, 2014

Related U.S. Application Data
(63) Continuation of application No. PCT/JP2013/064481, filed on May 24, 2013.

(30) Foreign Application Priority Data
May 29, 2012 (JP) 2012-122044

(51) Int. Cl. H04R 29/00; H04R 17/00

(52) U.S. Cl. CPC H04R 29/001; H04R 17/00
USPC 381/59

(57) ABSTRACT

An electronic device and methods are disclosed. A cover panel is located on a front surface of the electronic device. A piezoelectric vibration module configured to vibrate the cover panel. A drive module configured to vibrate the piezoelectric vibration module based on a sound signal. A pressure intensity acquiring module configured to acquire pressure intensity information. The pressure intensity information indicates an intensity at which an ear of a user is pressed onto the cover panel. A sound quality controller configured to control a sound quality of the sound signal based on the pressure intensity information.

The present application is a bypass continuation of international patent application PCT Application No. PCT/JP2013/064481, filed on May 24, 2013, entitled

“ELECTRONIC DEVICE”, which claims the benefit of Japanese Application No. 2012-122044, filed on May 29, 2012, entitled “ELECTRONIC DEVICE”. The disclosure of each of the above is incorporated herein by reference in its entirety.

### TECHNICAL FIELD

Embodiments of the present disclosure relate to electronic devices, and more particularly relate to electronic devices transmitting sound to a user.

### BACKGROUND ART

Various technologies have been conventionally proposed for electronic devices.

### SUMMARY

An electronic device and methods are disclosed. A cover panel is located on a front surface of the electronic device. A piezoelectric vibration module configured to vibrate the cover panel. A drive module configured to vibrate the piezoelectric vibration module based on a sound signal. A pressure intensity acquiring module configured to acquire pressure intensity information. The pressure intensity information indicates an intensity at which an ear of a user is pressed onto the cover panel. A sound quality controller configured to control a sound quality of the sound signal based on the pressure intensity information.

In one embodiment, a method for controlling an electronic device comprising a cover panel vibrates the cover panel based on a sound signal. The method then acquires pressure intensity information indicating a pressure intensity at which an ear of a user is pressed onto the cover panel and controls a sound quality of the sound signal based on the pressure intensity information.

### BRIEF DESCRIPTION OF THE DRAWINGS

FIG. 1 illustrates a perspective view showing an external appearance of an electronic device.

FIG. 2 illustrates a front view showing the external appearance of the electronic device.

FIG. 3 illustrates a rear view showing the external appearance of the electronic device.

FIG. 4 illustrates a block diagram mainly showing an electrical configuration of the electronic device.

FIG. 5 illustrates a top view showing a structure of a piezoelectric vibration element.

FIG. 6 illustrates a side view showing the structure of the piezoelectric vibration element.

FIG. 7 illustrates a view showing a state where the piezoelectric vibration element produces flexural vibrations.

FIG. 8 illustrates another view showing the state where the piezoelectric vibration element produces flexural vibrations.

FIG. 9 illustrates a view showing a vertical cross-sectional structure of the electronic device.

FIG. 10 illustrates a plan view showing a cover panel viewed from an inner main surface side thereof.

FIG. 11 illustrates a view for describing air conducted sound and conduction sound.

FIG. 12 illustrates a block diagram showing a partial configuration of the electronic device.

FIG. 13 illustrates a diagram showing exemplary frequency characteristics of a sound signal after sound quality control.

FIG. 14 illustrates a flowchart showing operations of the electronic device.

### DESCRIPTION OF EMBODIMENT

### <External Appearance of Electronic Device>

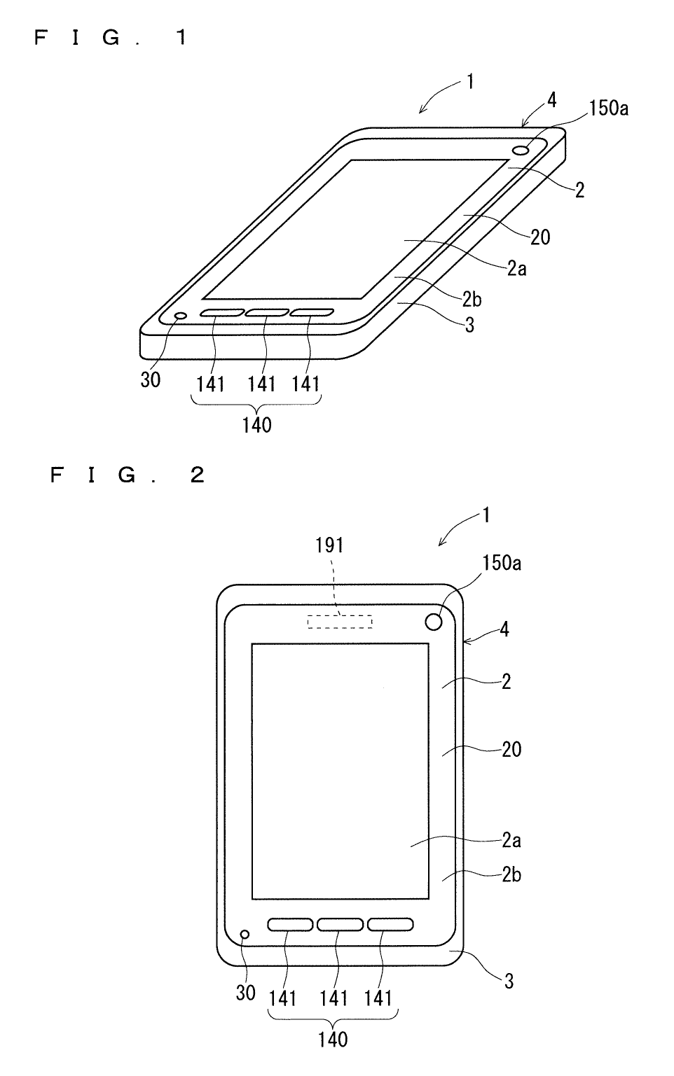

FIGS. 1 to 3 illustrate a perspective view, a front view, and a rear view showing an external appearance of an electronic device 1 according to an embodiment, respectively. The electronic device 1 according to this embodiment is, for example, a mobile phone. As shown in FIGS. 1 to 3, the electronic device 1 comprises a cover panel 2 and a case part 3. The cover panel 2 and the case part 3 are combined to constitute a device case 4 having a plate shape substantially rectangular in plan view.

The cover panel 2 has a substantially rectangular shape in plan view. The cover panel 2 forms a part in a front part of the electronic device 1 other than a peripheral part thereof. The cover panel 2 is formed of, for example, a transparent glass or a transparent acrylic resin. The case part 3 forms the peripheral part of the front part, a lateral part, and a rear part of the electronic device 1. The case part 3 is formed of, for example, a polycarbonate resin.

The cover panel 2 is provided with a display part 2a on which various types of information such as characters, symbols, and diagrams are displayed. The display part 2a has, for example, a rectangular shape in plan view. A peripheral part 2b that surrounds the display part 2a in the cover panel 2 is black through, for example, application of a film. The peripheral part 2b accordingly serves as a non-display part on which no information is displayed. Attached to an inner main surface of the cover panel 2 comprises a touch panel 130, which will be described below. The user can provide various instructions to the electronic device 1 by manipulating the display part 2a of the cover panel 2 with, for example, his/her finger.

A manipulation module 140 may be provided inside the device case 4. The manipulation module 140 comprises a plurality of manipulation buttons 141. Each manipulation button 141 is a so-called “hard key,” and the surface thereof is exposed from a lower-side end portion of an outer main surface 20 of the cover panel 2. Made in the lower-side end portion of the cover panel 2 is a microphone hole 30. Visible from an upper-side end portion of the outer main surface 20 of the cover panel 2 is an imaging lens 150a of a front-side imaging module 150, which will be described below. Although three manipulation buttons 141 being “hard keys” are provided in the electronic device 1 according to this embodiment, the number of the manipulation buttons 141 may be appropriately changed. Alternatively, no manipulation button 141 may be provided.

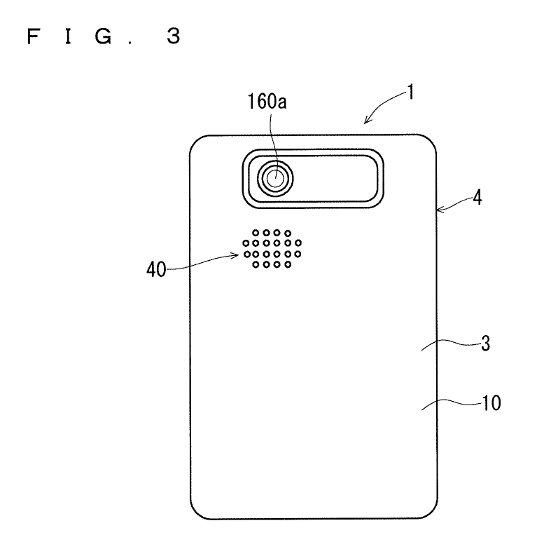

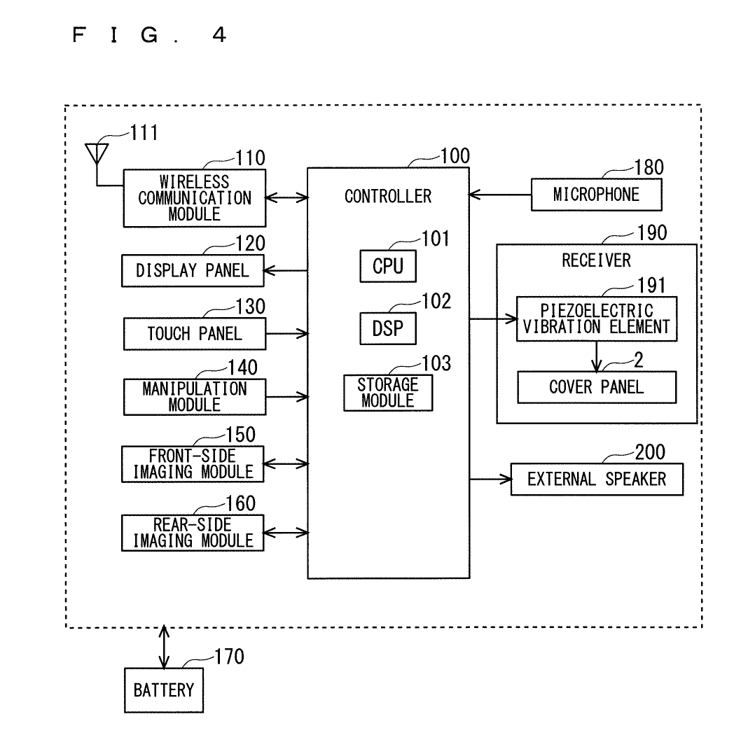

As shown in FIG. 2, a piezoelectric vibration element 191 is provided inside the device case 4. As shown in FIG. 3, speaker holes 40 are made in a rear surface 10 of the electronic device 1, namely, in a rear surface of the device case 4. Visible from the rear surface 10 of the electronic device 1 is an imaging lens 160a of a rear-side imaging module 160, which will be described below.

### <Electrical Configuration of Electronic Device>

FIG. 4 illustrates a block diagram mainly showing an electrical configuration of the electronic device 1. The electronic device 1 comprise a controller 100, a wireless communication module 110, a display panel 120, the touch panel 130, the manipulation module 140, the front-side imaging module 150, and the rear-side imaging module 160. The electronic device 1 further comprises a receiver 190 configured with the piezoelectric vibration element 191 and the cover panel 2, a microphone 180, an external speaker 200, and a battery 170. These components of the electronic device 1 except for the cover panel 2 are housed in the device case 4.

The controller 100 can control other components of the electronic device 1 to collectively manage the operation of the electronic device 1. The controller 100 mainly comprises a CPU (central processing unit) 101, a DSP (digital signal processor) 102, and a storage module 103.

The storage module 103 is configured with a non-transitory recording medium that can be read by the controller 100 (CPU 101 and DSP 102), such as a ROM (read only memory) and a RAM (random access memory). The storage module 103 can store a main program being a control program for controlling the operation of the electronic device 1, specifically, the components such as the wireless communication module 110 and the display panel 120 included in the electronic device 1, a plurality of application programs, and the like. The various functions of the controller 100 can be implemented by the CPU 101 and the DSP 102 executing the various programs in the storage module 103.

The storage module 103 may include a computer-readable, non-transitory recording medium, except for the ROM and RAM. The storage module 103 may include, for example, a small hard disk drive, a small SSD (solid state drive), and the like.

The wireless communication module 110 can receive, through an antenna 111, a signal from a mobile phone different from the electronic device 1 or a communication device such as a web server connected to the Internet via a base station. The wireless communication module 110 can perform amplification processing and down-conversion processing on the received signal and then outputs a resultant signal to the controller 100. The controller 100 can perform modulation processing or other processing on a received signal that has been input, to thereby obtain, for example, a sound signal indicative of voice or music comprised in the received signal. Also, the wireless communication module 110 performs up-conversion processing and amplification processing on a transmission signal including the sound signal or the like that has been generated by the controller 100, to thereby wirelessly transmit the processed transmission signal from the antenna 111. The transmission signal from the antenna 111 is received, via the base station, by a mobile phone different from the electronic device 1 or a communication device connected to the Internet.

The display panel 120 comprises, for example, a liquid crystal display panel or an organic EL panel. The display panel 120 can display various types of information such as characters, symbols, and graphics under control of the controller 100. The information, which is to be displayed on the display panel 120, is displayed in the display part 2a of the cover panel 2 to be visible to the user of the electronic device 1.

The touch panel 130 comprises, for example, a projected capacitive type touch panel. The touch panel 130 can detect the contact of an object with the display part 2a of the cover panel 2. The touch panel 130 may be bonded to the inner main surface of the cover panel 2 and comprises two sheet-like electrode sensors disposed to face each other. The two electrode sensors are bonded together with a transparent adhesive sheet.

Formed in one of the electrode sensors are a plurality of elongated X electrodes that extend in the X-axis direction (for example, the horizontal direction of the electronic device 1) and are disposed parallel to one another. Formed in the other electrode sensor are a plurality of elongated Y electrodes that extend in the Y-axis direction (for example, the vertical direction of the electronic device 1) and are disposed parallel to one another. When the user's finger or the like comes into contact with the display part 2a of the cover panel 2, a capacitance between the X electrode and the Y electrode located below the contact portion changes, so that the touch panel 130 detects the manipulation on (contact with) the display part 2a of the cover panel 2. A change in the capacitance between the

X electrode and the Y electrode, which occurs in the touch panel 130, is transmitted to the controller 100. The controller 100 identifies, based on the capacitance change, the description of the manipulation made on the display part 2a of the cover panel 2, and performs the operation corresponding to the identified description.

For each of the plurality of manipulation buttons 141, when the user presses a manipulation button 141, the manipulation module 140 outputs to the controller 100 a manipulation signal indicating that the manipulation button 141 has been pressed. The controller 100 identifies, based on the input manipulation signal, which manipulation button 141 of the plurality of manipulation buttons 141 has been manipulated and then performs the operation corresponding to the manipulation button 141 that has been manipulated.

The front-side imaging module 150 is configured with the imaging lens 150a, an imaging element, and the like. The front-side imaging module 150 takes a still image and a moving image under the control of the controller 100. As shown in FIGS. 1 and 2, the imaging lens 150a is provided on the front surface of the electronic device 1. This allows the front-side imaging module 150 to take an image of the object located on the front side (cover panel 2 side) of the electronic device 1.

The rear-side imaging module 160 comprises the imaging lens 160a, an imaging element, and the like. The rear-side imaging module 160 can take a still image and a moving image under the control of the controller 100. As shown in FIG. 3, the imaging lens 160a is provided on the rear surface 10 of the electronic device 1. The rear-side imaging module 160 can take an image of the object located on the rear surface 10 side of the electronic device 1.

The microphone 180 can convert the sound input from the outside of the electronic device 1 into an electrical sound signal and then can output the electrical sound signal to the controller 100. The sound from the outside of the electronic device 1 is taken inside the electronic device 1 through the microphone hole 30, and the sound from the outside is input to the microphone 180. The microphone hole 30 may be provided in the lateral surface of the electronic device 1 or may be provided in the rear surface 10.

The external speaker 200 comprises, for example, a dynamic speaker (an electromagnetic speaker), and can convert an electrical sound signal from the controller 100 into sound and then outputs the sound. The sound output from the external speaker 200 is output to the outside through the speaker holes 40. The user can hear the sound output through the speaker holes 40 in the place apart from the electronic device 1.

The receiver 190 can transmit received sound to the user and comprises the piezoelectric vibration element 191 and the cover panel 2. The receiver 190 can output sound with a volume lower than that of the external speaker 200. The receiver 190 can output the sound high enough for the user to hear when the user brings his/her ear near or into contact with the cover panel 2. The piezoelectric vibration element 191 is provided on the inner main surface of the cover panel 2 and is vibrated upon application of the drive voltage applied from the controller 100. The controller 100 generates a drive voltage based on a sound signal, and then applies the drive voltage to the piezoelectric vibration element 191. The piezoelectric vibration element 191 is vibrated based on a sound signal by the controller 100, whereby the cover panel 2 vibrates based on the sound signal, transmitting the received sound to the user.

The battery 170 can output a power supply for the electronic device 1. The power supply output from the battery 170 is supplied to the electronic components included in the controller 100, the wireless communication module 110, and the like of the electronic device 1.

### <Details of Piezoelectric Vibration Element>

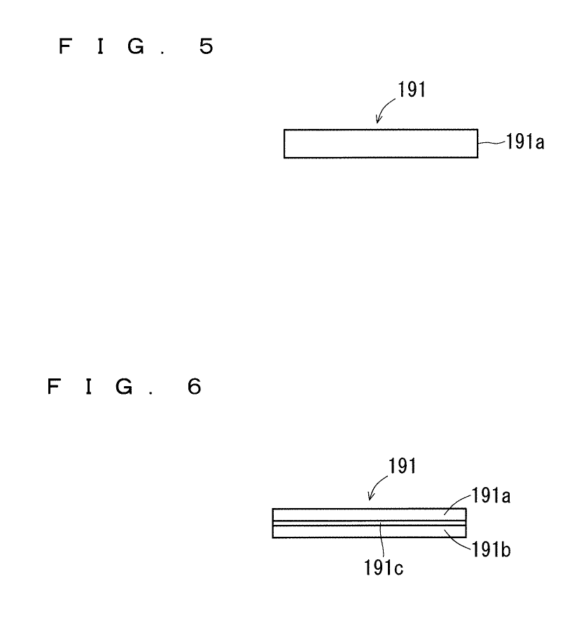

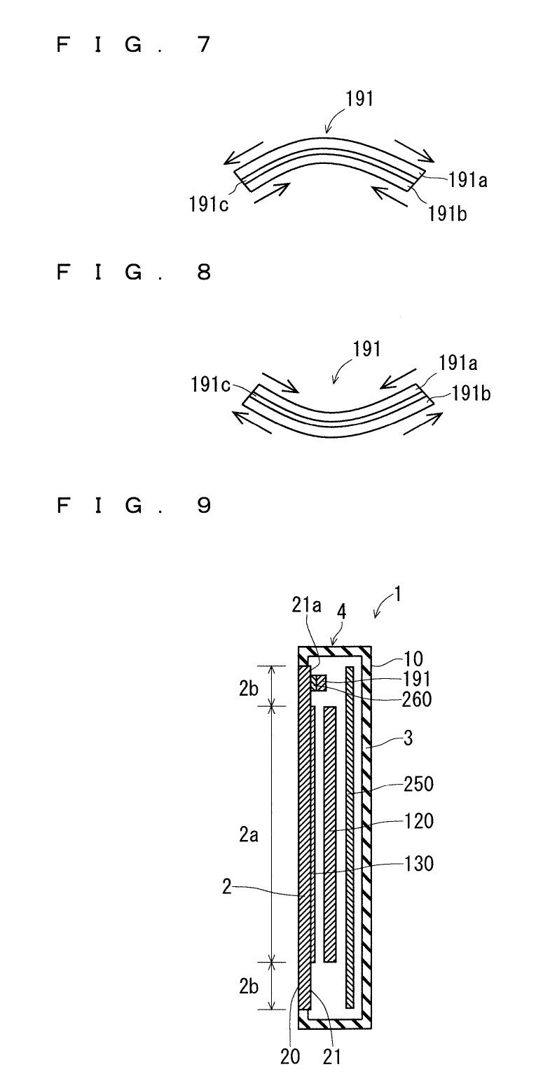

FIGS. 5 and 6 illustrate a top view and a side view showing the structure of the piezoelectric vibration element 191, respectively. As shown in FIGS. 5 and 6, the piezoelectric vibration element 191 is long in one direction. The piezoelectric vibration element 191 has an elongated plate shape rectangular in plan view. The piezoelectric vibration element 191 has, for example, a bimorph structure. The piezoelectric vibration element 191 comprises a first piezoelectric ceramic plate 191a and a second piezoelectric ceramic plate 191b bonded to each other with a shim material 191c therebetween.

In the piezoelectric vibration element 191, a positive voltage is applied to the first piezoelectric ceramic plate 191a and a negative voltage is applied to the second piezoelectric ceramic plate 191b, so that the first piezoelectric ceramic plate 191a expands in the long-side direction and the second piezoelectric ceramic plate 191b contracts in the long-side direction. This causes, as shown in FIG. 7, the piezoelectric vibration element 191 to flex toward the first piezoelectric ceramic plate 191a in a convex manner.

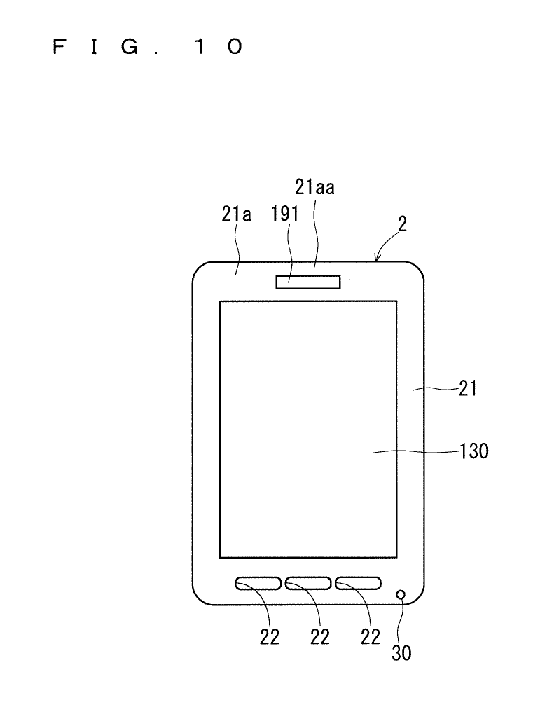

In the piezoelectric vibration element 191, meanwhile, a negative voltage is applied to the first piezoelectric ceramic plate 191a and a positive voltage is applied to the second piezoelectric ceramic plate 191b, so that the first piezoelectric ceramic plate 191a contracts in the long-side direction and the second piezoelectric ceramic plate 191b expands in the long-side direction. This causes, as shown in FIG. 8, the piezoelectric vibration element 191 to flex toward the second piezoelectric ceramic plate 191b in a convex manner.

The piezoelectric vibration element 191 alternately enters the state of FIG. 7 and the state of FIG. 8, to thereby produce flexural vibrations. The controller 100 causes an AC voltage, which alternates between positive and negative voltages, to be applied between the first piezoelectric ceramic plate 191a and the second piezoelectric ceramic plate 191b, causing the piezoelectric vibration element 191 to produce flexural vibrations.

While the piezoelectric vibration element 191 shown in FIGS. 5 to 8 is provided with a single structure configured with the first piezoelectric ceramic plate 191a and the second piezoelectric ceramic plate 191b that are bonded with the shim material 191c sandwiched therebetween, a plurality of the above-mentioned structures may be laminated.

<Position at which Piezoelectric Vibration Element is Disposed>

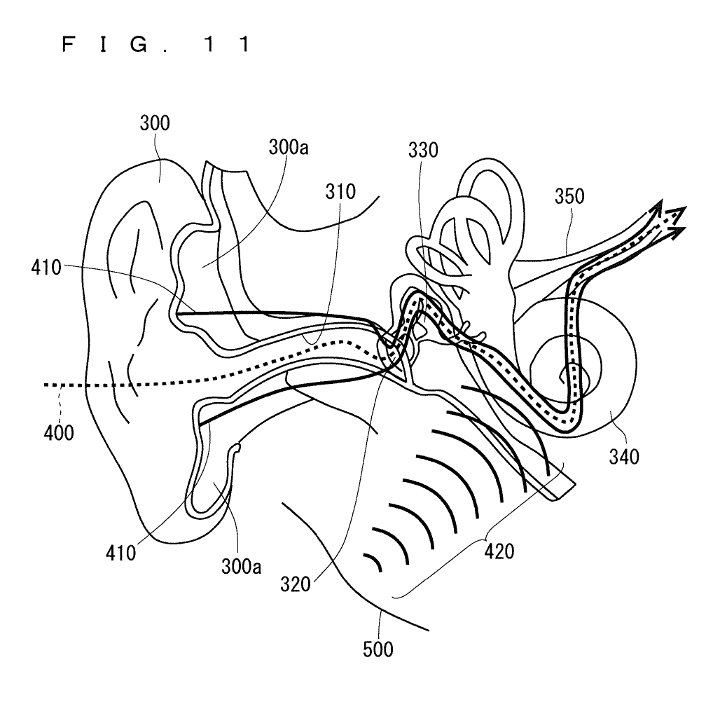

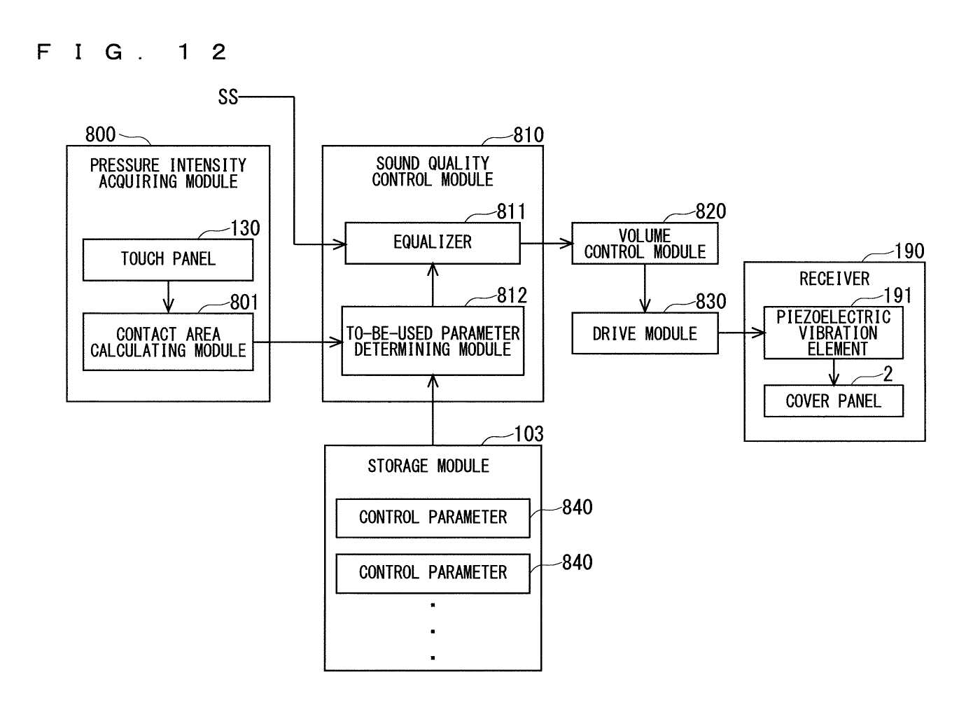

FIG. 9 illustrates a view showing the cross-sectional structure in the vertical direction (long-side direction) of the electronic device 1. FIG. 10 illustrates a plan view of the cover panel 2 when viewed from its inner main surface 21 side thereof.

As shown in FIGS. 9 and 10, the touch panel 130 is bonded to the inner main surface 21 of the cover panel 2. The touch panel 130 faces the display part 2a of the cover panel 2. The display panel 120 is disposed to face the cover panel 2 and the touch panel 130. The touch panel 130 is thus located between the cover panel 2 and the display panel 120. The part of the cover panel 2, which faces the display panel 120, serves as the display part 2a.

A printed circuit board 250 is provided inside the device case 4. Various components such as the CPU 101 and the DSP 102 are mounted on the printed circuit board 250. The printed circuit board 250 is disposed to face the display panel 120 on the side closer to the rear surface 10 than the display panel 120. As shown in FIG. 10, a plurality of holes 22 for respectively exposing the plurality of manipulation buttons 141 are made in the lower-side end portion of the cover panel 2.

The piezoelectric vibration element 191 is bonded to the inner main surface 21 of the cover panel 2 with an adhesive 260 such as a double-sided tape. The piezoelectric vibration element 191 is disposed, on the inner main surface 21 of the cover panel 2, at a position at which the piezoelectric vibration element 191 does not overlap the display panel 120 and the touch panel 130 in plan view of the cover panel 2 viewed from the inner main surface 21 side. In other words, when the cover panel 2 is viewed from the inner main surface 21 side in the thickness direction of the cover panel 2, the piezoelectric vibration element 191 is disposed, on the inner main surface 21, at a position at which the piezoelectric vibration element 191 does not overlap the display panel 120 and the touch panel 130. Therefore, the touch panel 130 and the display panel 120 are not located between the cover panel 2 and the piezoelectric vibration element 191.

The piezoelectric vibration element 191 is provided on the upper-side end portion 21a of the inner main surface 21 of the cover panel 2. To be specific, as shown in FIG. 10, the piezoelectric vibration element 191 is provided on a center portion 21 aa in the horizontal direction (the short-side direction perpendicular to the long-side direction) at the upper-side end portion 21a of the inner main surface 21 of the cover panel 2.

The piezoelectric vibration element 191 is disposed such that its long-side direction coincides with the horizontal direction of the cover panel 2. The piezoelectric vibration element 191 is disposed at the center portion 21aa of the upper-side end portion 21a of the inner main surface 21 of the cover panel 2 such that the center in the long-side direction thereof coincides with the center in the horizontal direction at the upper-side end portion 21a.

As shown in FIGS. 7 and 8 described above, the piezoelectric vibration element 191 that produces flexural vibrations has the largest displacement amount at the center in the long-side direction thereof. Thus, disposing the piezoelectric vibration element 191 at the upper-side end portion 21a such that the center in the long-side direction thereof coincides with the center in the horizontal direction at the upper-side end portion 21a of the inner main surface 21 of the cover panel 2 allows the part of the piezoelectric vibration element 191, which has the largest displacement amount of flexural vibrations, to coincide with the center in the horizontal direction at the upper-side end portion 21a of the inner main surface 21 of the cover panel 2.

In the case where the touch panel 130 is located over the entire inner main surface 21 of the cover panel 2, the piezoelectric vibration element 191 may be disposed on the inner main surface 21 of the cover panel 2 with the touch panel 130 therebetween.

While a clearance is provided between the touch panel 130 and the display panel 120 in the above-mentioned example as shown in FIG. 9, the touch panel 130 and the display panel 120 may be brought into contact with each other. A clearance, provided between the touch panel 130 and the display panel 120 as in this embodiment, can prevent the cover panel 2 from hitting the display panel 120 (more accurately, the touch panel 130 from hitting the display panel 120) even if the cover panel 2 flexes toward the display panel 120 by being pressed by the user with, for example, his/her finger. This prevents a display of the display panel 120 from being disturbed by the cover panel 2 hitting the display panel 120.

### <Generation of Received Sound by Receiver>

In the receiver 190 according to this embodiment, the piezoelectric vibration element 191 causes the cover panel 2 to vibrate, so that air conducted sound and conduction sound are transmitted to the user from the cover panel 2. In other words, the vibrations of the piezoelectric vibration element 191 itself are transmitted to the cover panel 2, allowing for the transmission of air conducted sound and conduction sound to the user from the cover panel 2.

Herein, the air conducted sound is the sound recognized by the human brain when a sound wave (air vibrations), which has entered the external auditory meatus (so-called “earhole”), causes the eardrum to vibrate. Meanwhile, the conduction sound is the sound recognized by the human brain when the auricle is vibrated. The air conducted sound and conduction sound will now be described in detail.

FIG. 11 is a view for describing the air conducted sound and conduction sound. FIG. 11 shows the structure of ear of the user of the electronic device 1. In FIG. 11, a dashed line 400 indicates a conductive path of a sound signal (sound information) when the air conducted sound is recognized by the brain, and a solid line 410 indicates a conductive path of a sound signal when the conduction sound is recognized by the brain.

When the piezoelectric vibration element 191 mounted on the cover panel 2 is vibrated based on an electrical sound signal indicative of received sound, the cover panel 2 vibrates, whereby a sound wave is output from the cover panel 2. When the user has the electronic device 1 in his/her hand and brings the cover panel 2 of the electronic device 1 near an auricle 300 of the user or presses the cover panel 2 of the electronic device 1 onto (brings the cover panel 2 of the electronic device 1 into contact with) the auricle 300 of the user, the sound wave output from the cover panel 2 enters an external auditory meatus 310. The sound wave from the cover panel 2 travels through the external auditory meatus 310 and causes an eardrum 320 to vibrate. The vibrations of the eardrum 320 are transmitted to an auditory ossicle 330, causing the auditory ossicle 330 to vibrate. Then, the vibrations of the auditory ossicle 330 are transmitted to a cochlea 340 and are then converted into an electrical signal in the cochlea 340. The electrical signal is transmitted to the brain through an auditory nerve 350, so that the brain recognizes the received sound. In this manner, the air conducted sound is transmitted from the cover panel 2 to the user.

When the user has the electronic device 1 in his/her hand and presses the cover panel 2 of the electronic device 1 onto the auricle 300 of the user, the auricle 300 is vibrated by the cover panel 2 vibrated by the piezoelectric vibration element 191. As indicated by the solid line 410, the vibrations of the auricle 300 are transmitted to the eardrum 320, causing the eardrum 320 to vibrate. The vibrations of the eardrum 320 are transmitted to the auditory ossicle 330, causing the auditory ossicle 330 to vibrate. The vibrations of the auditory ossicle 330 are then transmitted to the cochlea 340 and are then converted into an electrical signal in the cochlea 340. Differently from the transmission through the conductive path indicated by the solid line 410, in some cases, the vibrations of the auricle 300 are transmitted directly to the cochlea 340 without being transmitted to the eardrum 320, and the vibrations are converted into an electrical signal in the cochlea 340. The electrical signal obtained in the cochlea 340 is transmitted to the brain through the auditory nerve 350, whereby the brain recognizes the received sound. In this manner, the conduction sound is transmitted from the cover panel 2 to the user. FIG. 11 also shows an auricular cartilage 300a inside the auricle 300.

The conduction sound described herein differs from bone-conducted sound (also referred to as “bone conduction sound”). The bone-conducted sound is the sound recognized by the human brain when the skull is vibrated and the vibrations of the skull directly stimulate the inner ear such as the cochlea. In FIG. 11, showing the case in which, for example, a mandibular bone 500 is vibrated, a plurality of arcs 420 indicate a transmission path of a sound signal when the bone conduction sound is recognized by the brain.

As described above, in the electronic device 1 according to this embodiment, the piezoelectric vibration element 191 appropriately vibrates the cover panel 2 on the front surface, so that the air conducted sound and conduction sound can be transmitted from the cover panel 2 to the user of the electronic device 1. The structure of the piezoelectric vibration element 191 according to this embodiment is contrived to appropriately transmit the air conducted sound and conduction sound to the user. Various advantages can be achieved by configuring the electronic device 1 to transmit the air conducted sound and conduction sound to the user.

For example, the user can hear the sound by placing the cover panel 2 to his/her ear, and thus can have a telephone conversation without much consideration of the position where the user places his/her ear to the electronic device 1.

For large ambient noise, the user can make it difficult to hear the ambient noise by pressing his/her ear strongly onto the cover panel 2 while turning up the volume of the conduction sound. This enables the user to appropriately have a telephone conversation even if the ambient noise is large.

Even while wearing earplugs or earphones in his/her ears, the user can recognize the received sound from the electronic device 1 by placing the cover panel 2 to his/her ear (more specifically, auricle). Alternatively, even while wearing headphones in his/her ears, the user can recognize the received sound from the electronic device 1 by placing the cover panel 2 to the headphones.

As described above, in the receiver 190 according to this embodiment, the piezoelectric vibration element 191 vibrated based on a sound signal vibrates the cover panel 2, transmitting the sound to the user. This eliminates the need for providing a receiver hole (earpiece hole) to the cover panel 2, unlike the case in which a dynamic speaker is used for the receiver 190.

### <Sound Quality Control of Received Sound>

As described above, in the receiver 190, the piezoelectric vibration element 191 vibrates the cover panel 2, causing the sound transmission from the cover panel 2 to the user. For this reason, compared with the sound output from, for example, the dynamic speaker used in the external speaker 200, the sound transmitted from the receiver 190 to the user tends to have a minimum resonance frequency f0 located at a high frequency side, resulting in that the level (sound pressure) of low frequency components tends to be low. The above-mentioned tendency holds true for the piezoelectric speaker as well.

Meanwhile, for the conduction sound transmitted from the cover panel 2 of the receiver 190 to the user, the low frequency components tend to be more easily transmitted to the user than high frequency components, compared with the air conducted sound transmitted from the cover panel 2 to the user. When the user presses his/her ear strongly onto the cover panel 2, the volume of the conduction sound increases, and the minimum resonance frequency f0 of the sound transmitted from the cover panel 2 to the user moves toward lower frequencies. This may result in that the level of low frequency components will become higher. For the sound transmitted from the cover panel 2 to the user, thus, the low frequency components tend to be more easily transmitted to the user in the case where the user strongly presses his/her ear onto the cover panel 2 than in the case where the user weakly presses his/her ear onto the cover panel 2.

As described above, the sound transmitted from the receiver 190 to the user tends to have a lower level of low frequency components than the sound transmitted from a dynamic speaker, while low frequency components tend to be easily transmitted to the user when the user strongly presses his/her ear onto the cover panel 2.

In the electronic device 1 according to this embodiment, therefore, the sound quality of the sound transmitted from the receiver 190 to the user is controlled based on the intensity of pressing the user's ear onto the cover panel 2 (intensity at which the user presses his/her ear onto the cover panel 2), to thereby improve the sound quality of the sound transmitted from the receiver 190 to the user. The sound quality control in the electronic device 1 will now be described in detail. In the following description, mere “pressure intensity” refers to the intensity of pressing the user's ear onto the cover panel 2.

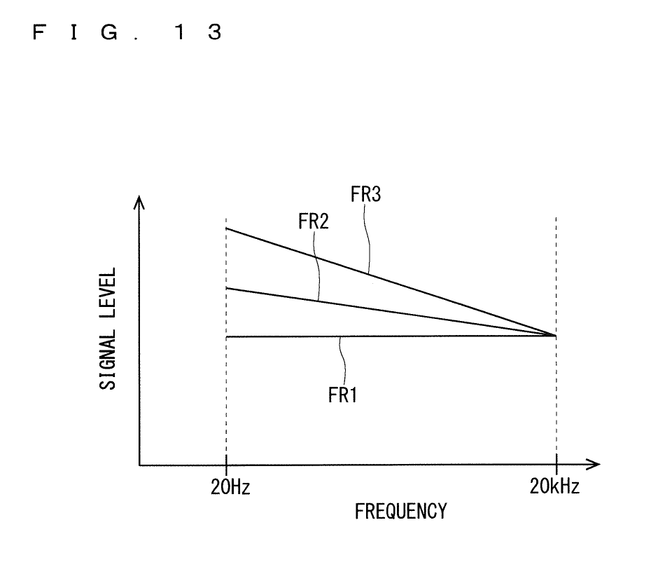

FIG. 12 illustrates a block diagram mainly showing the configuration for sound quality control in the electronic device 1. As shown in FIG. 12, the electronic device 1 comprises a pressure intensity acquiring module 800, a sound quality control module 810, a volume control module 820, and a drive module 830. A drive module 800 can vibrate the piezoelectric vibration element 191.

The pressure intensity acquiring module 800 can acquire the pressure intensity information. The pressure intensity indicates pressure intensity. The pressure intensity acquiring module 800 comprises the touch panel 130 and a contact area calculating module 801. The contact area calculating module 801 may be a functional block to be formed in the controller 100. The contact area calculating module 801 can calculate the contact area of the user's ear with the cover panel 2. The contact area calculating module 801 can calculate the contact area based on the output signal from the touch panel 130. The contact area increases with an increasing pressure intensity, and thus, it can be said that the contact area indicates pressure intensity. The contact area calculating module 801 outputs the determined contact area to the sound quality control module 810 as pressure intensity information. Hereinafter, mere “contact area” refers to the contact area of the user's ear with the cover panel 2.

The sound quality control module 810 can control the sound quality of a sound signal SS. The sound signal SS is used in controlling the vibrations of the piezoelectric vibration element 191 by the drive module 830. The sound quality control module 810 can control the sound quality of a sound signal SS based on the pressure intensity information acquired in the pressure intensity acquiring module 800. The sound quality control module 810 comprises an equalizer 811 and a to-be-used parameter determining module 812.

The equalizer 811 can control the sound quality of the sound signal SS by controlling the frequency characteristics of the sound signal SS. The equalizer 811 can control the frequency characteristics based on a control parameter 840 stored in the storage module 103. The frequency characteristics represent a signal level at each frequency. The to-be-used parameter determining module 812 can determine a control parameter 840 to be used by the equalizer 811. The equalizer 811 is provided in the controller 100. The to-be-used parameter determining module 812 may be a function block to be formed in the controller 100.

The storage module 103 can store a plurality of types of control parameters 840. The plurality of types of control parameters 840 have frequency characteristics of the sound signal SS different from one another, which are acquired by being controlled by the equalizer 811 based on a control parameter 840. In other words, a plurality of types of control parameters 840 have sound qualities of the sound signal SS different from one another, which are acquired by being controlled by the equalizer 811 based on a control parameter 840. The sound quality control module 810 can thus change the frequency characteristics of the sound signal SS to a plurality of types of frequency characteristics depending on a control parameter 840 to be used. The to-be-used parameter determining module 812 determines, based on the pressure intensity information acquired by the pressure intensity acquiring module 800, a control parameter 840 to be used by the equalizer 811 from the plurality of types of control parameters 840 stored in the storage module 103. The equalizer 811 controls the frequency characteristics of the sound signal SS based on the control parameter 840 determined to be used based on the pressure intensity information by the to-be-used parameter determining module 812. In other words, the equalizer 811 controls the sound quality of the sound signal SS based on the control parameter 840, whose use has been determined based on the pressure intensity information by the to-be-used parameter determining module 812. The sound signal SS whose frequency characteristics have been controlled by the sound quality control module 810 is input to the volume control module 820.

The volume control module 820 may be a functional block to be formed in the controller 100. The volume control module 820 can control the volume of the sound signal SS whose sound quality has been controlled, based on a volume setting instruction from the user. For example, when the user manipulates the display part 2a and instructs the electronic device 1 to turn up the current volume of the sound from the receiver 190, the volume control module 820 increases the signal level of the sound signal SS after the sound quality control, thereby turning up the volume of this sound signal SS. The sound signal SS whose sound quality and volume have been controlled is input to the drive module 830.

The drive module 830 can vibrate the piezoelectric vibration element 191 of the receiver 190 based on the sound signal SS whose sound quality and volume have been controlled. This causes the cover panel 2 to vibrate based on the sound signal SS whose sound quality and volume have been controlled, so that the sound having desired frequency characteristics is transmitted from the cover panel 2 to the user.

The electronic device 1 according to this embodiment is configured such that the sound quality control module 810 increases the signal level of low frequency components comprised in the sound signal SS as the pressure intensity indicated by the pressure intensity information is lower.

In this embodiment, for example, in the case where the contact area is greater than a threshold (>0), the frequency characteristics of the sound signal SS are controlled so as to obtain first frequency characteristics whose signal level is flat at the entire frequency band for the signal components comprised in the sound signal SS.

In the case where the contract area is greater than zero and not greater than the threshold, the frequency characteristics of the sound signal SS are controlled so as to obtain second frequency characteristics having a signal level of low frequency components that is higher than that of the first frequency characteristics.

In the case where the contact area is zero, as in the case where the user listens to the sound from the cover panel 2 without his/her ear being in contact with the cover panel 2, the frequency characteristics of the sound signal SS are controlled so as to obtain third frequency characteristics having a signal level of low frequency components that is higher than that of the second frequency characteristics.

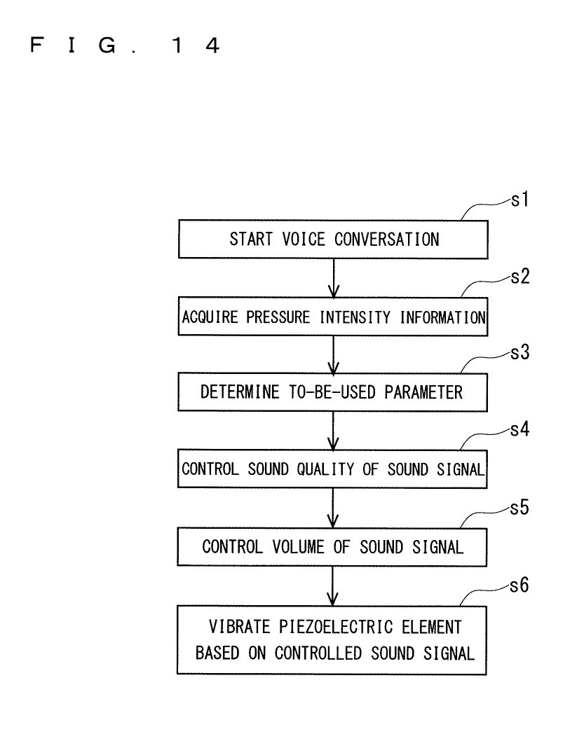

FIG. 13 illustrates a diagram showing exemplary first frequency characteristics FR1, second frequency characteristics FR2, and third frequency characteristics FR3. In this embodiment, the sound signal SS comprises signal components at audio frequency bands (20 Hz to 20 kHz). The first frequency characteristics FR1 shown in FIG. 13 have a flat (identical) signal level at all the frequency bands (20 Hz to 20 kHz) of the signal components comprised in the sound signal SS. The second frequency characteristics FR2 shown in FIG. 13 have signal levels higher than the first frequency characteristics FR1 at all the frequency bands of the signal components comprised in the sound signal SS. Additionally, the second frequency characteristics FR2 have higher signal levels at lower frequencies. The third frequency characteristics FR3 shown in FIG. 13 have signal levels higher than the second frequency characteristics FR2 at all the frequency bands of the signal components comprised in the sound signal SS. Additionally, the third frequency characteristics FR3 have higher signal levels at lower frequencies.

In the example of FIG. 13, the second frequency characteristics FR2 have higher signal levels than the first frequency characteristics FR1 at all the frequency bands of the signal components comprised in the sound signal SS. Alternatively, only the signal levels of the low frequency components may be higher than those of the first frequency characteristics FR1. For example, for the second frequency characteristics FR2, only the signal levels in the range from 20 Hz to the first third of the range from 20 Hz to 20 kHz (range from 20 Hz to 6.68 kHz) may be higher than those of the first frequency characteristics FR1. Similarly, for the third frequency characteristics FR3, only the signal levels of low frequency components may be higher than those of the second frequency characteristics FR2.

The storage module 103 stores a control parameter 840 corresponding to the first frequency characteristics FR1 (hereinafter, referred to as “first control parameter 840”), a control parameter 840 corresponding to the second frequency characteristics FR2 (hereinafter, referred to as “second control parameter 840”), and a control parameter 840 corresponding to the third frequency characteristics FR3 (hereinafter, referred to as “third control parameter 840”). In the sound quality control module 810, the to-be-used parameter determining module 812 reads the first control parameter 840 from the storage module 103 and then inputs the first control parameter 840 to the equalizer 811 in the case where the pressure intensity information acquired by the pressure intensity acquiring module 800, namely, the contact area is greater than the threshold. The equalizer 811 controls the frequency characteristics (sound quality) of the sound signal SS based on the input first control parameter 840. As a result, the controlled frequency characteristics for the sound signal SS turn into the first frequency characteristics FR1.

The to-be-used parameter determining module 812 reads the second control parameter 840 from the storage module 103 and then inputs the second control parameter 840 to the equalizer 811 in the case where the pressure intensity information acquired by the pressure intensity acquiring module 800, namely, the contact area is greater than zero and is not greater than the threshold. The equalizer 811 controls the frequency characteristics (sound quality) of the sound signal SS based on the input second control parameter 840. As a result, the controlled frequency characteristics for the sound signal SS turn into the second frequency characteristics FR2.

The to-be-used parameter determining module 812 reads the third control parameter 840 from the storage module 103 and then inputs the third control parameter 840 to the equalizer 811 in the case where the pressure intensity information acquired by the pressure intensity acquiring module 800, namely, the contact area is zero. The equalizer 811 controls the frequency characteristics (sound quality) of the sound signal SS based on the input third control parameter 840. As a result, the controlled frequency characteristics for the sound signal SS turn into the third frequency characteristics FR3.

In this embodiment, as described above, the signal levels of the low frequency components comprised in the sound signal SS become higher as the contact area is smaller, that is, the pressure intensity indicated by the pressure intensity information is lower. As described above, for the sound transmitted from the cover panel 2 of the receiver 190 to the user, the level of the low frequency components tends to be low compared with the sound transmitted from the dynamic speaker, while the low frequency components are tend to be easily transmitted to the user when the user strongly presses his/her ear onto the cover panel 2. Thus, the levels of the low frequency components comprised in the sound signal SS to be used in controlling the vibrations of the cover panel 2 are increased as the pressure intensities indicated by the pressure intensity information become lower, so that the sound with a desired sound quality can be transmitted from the cover panel 2 to the user even if the user does not strongly press his/her ear onto the cover panel 2. In other words, the signal levels of the low frequency components comprised in the sound signal SS to be used in controlling the vibrations of the cover panel 2 are reduced as the pressure intensities indicated by the pressure intensity information become higher, so that the sound with a desired sound quality can be transmitted from the cover panel 2 to the user irrespective of an intensity at which the user presses his/her ear onto the cover panel 2. In this example, the desired frequency characteristics for the sound transmitted to the user are the frequency characteristics whose level is flat at all the frequency bands. This allows the sound having frequency characteristics whose level is flat at all the frequency bands to be transmitted from the cover panel 2 to the user by controlling the sound quality of the sound signal SS based on the pressure intensity information, irrespective of the intensity at which the user presses his/her ear onto the cover panel 2.

Description will now be given of a series of operations of the electronic device 1 when the sound quality of the sound signal SS is controlled based on the pressure intensity information, and then the piezoelectric vibration element 191 is vibrated based on the sound signal SS having the controlled sound quality so that the sound from the cover panel 2 is transmitted to the user. FIG. 14 is a flowchart showing the series of operations. FIG. 14 shows the operations of the electronic device 1 when the electronic device 1 has a voice conversation with a communication partner device.

As shown in FIG. 14, in Step s1, the electronic device 1 starts a voice conversation with the communication partner device when the user manipulates a conversation button displayed on the display part 2a of the cover panel 2. Upon start of the voice conversation by the electronic device 1, the user brings or presses his/her ear near or onto the cover panel 2 to listen to the sound from the cover panel 2.

After the electronic device 1 starts a conversation, in Step s2, in the pressure intensity acquiring module 800, the contact area calculating module 801 determines the contact area of the user's ear with the cover panel 2 based on the output signal from the touch panel 130, and then, outputs the resultant as pressure intensity information. If the user merely brings his/her ear near the cover panel 2 and does not bring his/her ear into contact with the cover panel 2, the contact area is zero, that is, the pressure intensity is zero.

Then, in Step s3, in the sound quality control module 810, the to-be-used parameter determining module 812 determines a control parameter 840 to be used by the equalizer 811 based on the pressure intensity information (contact area) acquired in Step s2 as described above.

Then, in Step s4, the equalizer 811 controls the frequency characteristics of the sound signal SS based on the control parameter 840 whose use has been determined by the to-be-used parameter determining module 812, thereby controlling the sound quality of the sound signal SS.

Then, in Step s5, the volume control module 820 controls the volume of the sound signal SS whose sound quality has been controlled, based on the current volume setting value. After that, in Step s6, the drive module 830 vibrates the piezoelectric vibration element 191 based on the sound signal SS whose sound quality and volume have been controlled. This allows the transmission of the sound having desired frequency characteristics, in this example, frequency characteristics whose level is flat at all the frequency bands, from the cover panel 2 to the user.

While the electronic device 1 is in a voice conversation, the processes of Steps s2 to s6 described above are repeated regularly or irregularly. As a result, even if the pressure intensity varies while the electronic device 1 is in a voice conversation, the sound quality of the sound signal SS can be controlled appropriately.

In the example above, the sound quality of the sound signal SS to be used in controlling the vibrations of the cover panel 2 is controlled such that the frequency characteristics of the sound transmitted from the cover panel 2 to the user turn into the frequency characteristics whose level is flat at all the frequency bands. Alternatively, the sound quality of the sound signal SS may be controlled so as to have other frequency characteristics.

As described above, in this embodiment, the sound quality of the sound signal SS to be used in controlling the vibrations of the cover panel 2 is controlled based on the pressure intensity information indicating pressure intensity, allowing the transmission of the sound with a desired sound quality from the cover panel 2 to the user irrespective of pressure intensity. Therefore, the sound quality of the sound transmitted from the electronic device 1 to the user is improved.

### <Modifications>

Although the storage module 103 stores the first control parameter 840 to the third control parameter 840 in the example above, the storage module 103 may store only the third control parameter 840 thereamong. In this case, for a contact area greater than zero and not greater than a threshold, the to-be-used parameter determining module 812 changes the third control parameter 840 to generate a control parameter 840 corresponding to the second control parameter 840, and then inputs the resultant to the equalizer 811 as the control parameter 840 to be used. Then, for a contact area of zero, the to-be-used parameter determining module 812 changes the third control parameter 840 to generate a control parameter 840 corresponding to the first control parameter 840, and then, inputs the resultant to the equalizer 811 as the control parameter 840 to be used.

The storage module 103 may store only the first control parameter 840 among the first control parameter 840 to the third control parameter 840. In this case, for a contact area greater than zero and not greater than a threshold, the to-be-used parameter determining module 812 changes the first control parameter 840 to generate a control parameter 840 corresponding to the second control parameter 840, and then, inputs the resultant to the equalizer 811 as the control parameter 840 to be used. For a contact area greater than the threshold, the to-be-used parameter determining module 812 changes the first control parameter 840 to generate a control parameter 840 corresponding to the third control parameter 840, and then, inputs the resultant to the equalizer 811 as the control parameter 840 to be used.

Although the sound quality of the sound signal SS is adjustable by three levels according to pressure intensity in the example above, the sound quality of the sound signal SS may be adjustable by two levels according to pressure intensity, or the sound quality of the sound signal SS may be adjustable by four or more levels according to pressure intensity.

Although the pressure intensity acquiring module 800 is configured with the touch panel 130 and the contact area calculating module 801 in the example above, the pressure intensity acquiring module 800 may have other configuration. As an example, the pressure intensity acquiring module 800 may be configured with a pressure sensor formed of a piezoelectric element or the like, which detects the pressure applied to the cover panel 2. In this case, an output signal (output voltage) from the pressure sensor is the pressure intensity information indicating pressure intensity.

The volume control module 820 may turn up the volume of the sound signal SS as the pressure intensity indicated by the pressure intensity information is lower. As described above, the volume of the conduction sound from the cover panel 2 increases as the user presses his/her ear onto the cover panel 2 more strongly, whereby the volume of the sound transmitted from the cover panel 2 to the user becomes lower as the intensity at which the user presses his/her ear onto the cover panel 2 becomes lower. As in this example, therefore, by turning up the volume of the sound signal SS as the pressure intensity indicated by the pressure intensity information becomes lower, the sound having an appropriate volume can be transmitted from the cover panel 2 to the user irrespective of pressure intensity.

As described above, in the case where the volume of the sound signal SS is controlled based on pressure intensity information, for example, the volume of the sound signal SS that is set for a contact area greater than zero and not greater than a threshold is set to be higher than the volume of the sound signal SS that is set for a contact area larger than a threshold. Also, the volume of the sound signal SS that is set for a contact area of zero is set to be higher than the volume of the sound signal SS that is set for a contact area greater than zero and not greater than a threshold.

The receiver 190 may have other configuration. As an example, the receiver 190 may be configured with a dynamic receiver similarly to the external speaker 200 or may be configured with a piezoelectric speaker.

Although the examples above have been given of the case where the embodiments of the present disclosure are applied to a mobile phone, the embodiments of the present disclosure are also applicable to electronic devices other than mobile phones.

The electronic device 1 has been described in detail, but the above-mentioned description is illustrative in all aspects and the embodiments of the present disclosure are not intended to be limited thereto. The examples described above are applicable in combination as long as they do not contradict each other. Various modifications not exemplified are construed to be made without departing from the scope of the present disclosure.

### DESCRIPTION OF REFERENCE SIGNS

1 electronic device
2 cover panel
191 piezoelectric vibration element
800 pressure intensity acquiring module
810 sound quality control module
820 volume control module
830 drive module

1. An electronic device comprising:
a cover panel located on a front surface of the electronic device;
a piezoelectric vibration module configured to vibrate the cover panel;
a drive module configured to vibrate the piezoelectric vibration module based on a sound signal;
a pressure intensity acquiring module configured to acquire pressure intensity information, the pressure intensity information indicating a pressure intensity at which an ear of a user is pressed onto the cover panel; and
a sound quality control module configured to control a sound quality of the sound signal based on the pressure intensity information.

2. The electronic device according to claim 1, wherein the sound quality control module increases a signal level of low frequency components comprised in said sound signal as the pressure intensity becomes lower.

3. The electronic device according to claim 1,
further comprising a volume control module configured to control a volume of the sound signal, the volume control module turning up a volume of the sound signal as the pressure intensity becomes lower.

4. The electronic device according to claim 1,
wherein the piezoelectric vibration module vibrates the cover panel such that air conducted sound and conduction sound are transmitted from said cover panel to the user.

5. A method for controlling an electronic device comprising a cover panel, the method comprising:
vibrating the cover panel based on a sound signal;
acquiring pressure intensity information indicating a pressure intensity at which an ear of a user is pressed onto the cover panel; and
controlling a sound quality of the sound signal based on the pressure intensity information.
